(19) United States
(12) Patent Application Publication
(10) Pub. No.: US 2026/0225442 A1
(43) Pub. Date: Aug. 6, 2026

(54) IN-VEHICLE INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Ryoko WADA YOKOTA, Kawasaki-shi (JP); Junichiro TAMAO, Tokyo (JP); Naoki KOSAKA, Tokyo (JP); Takumi HORIE, Yokohama-shi (JP); Masaaki KUZUYA, Tokyo (JP)

(73) Assignee: TOYOTA JIDOSHA KABUSHIKI KAISHA, Toyota-shi (JP)

(21) Appl. No.: 19/529,840

(22) Filed: Feb. 4, 2026

(30) Foreign Application Priority Data
Feb. 5, 2025 (JP) 2025-017953

(51) Int. Cl. B60K 35/10; B60K 35/80

(52) U.S. Cl. CPC B60K 35/10; B60K 35/80; B60K 2360/148

(57) ABSTRACT

An in-vehicle information processing device includes a control unit having a plurality of VUI functions configured to be activated by the same activation phrase. The VUI functions are associated with respective in-vehicle functions. Each of the VUI functions is configured to perform speech recognition processing on an utterance from a user, recognize a voice command for an in-vehicle function, and execute the in-vehicle function based on the voice command. The control unit is configured to, when a predetermined in-vehicle function is active, activate the VUI function associated with the predetermined in-vehicle function in response to the activation phrase.

### CROSS-REFERENCE TO RELATED APPLICATION

This application claims priority to Japanese Patent Application No. 2025-017953 filed on February 5, 2025. The disclosure of the above-identified application, including the specification, drawings, and claims, is incorporated by reference herein in its entirety.

### BACKGROUND

### 1. Technical Field

The present disclosure relates to in-vehicle information processing devices and information processing methods.

### 2. Description of Related Art

Techniques relating to voice interaction services in vehicles are known. For example, Japanese Unexamined Patent Application Publication No. 2020-144275 (JP 2020-144275 A) discloses an agent device including a plurality of agent function units and a management unit. The agent function units provide services, including voice responses, in response to utterances from vehicle occupants. When a vehicle occupant speaks a first activation phrase individually assigned to one of the agent function units, the management unit activates one of the agent function units that corresponds to the spoken first activation phrase. When a vehicle occupant speaks a second activation phrase commonly assigned to two or more of the agent function units, the management unit activates two or more of the agent function units that correspond to the spoken second activation phrase.

### SUMMARY

However, when a plurality of voice user interface (VUI) functions is installed, a user needs to have knowledge of the combinations of activation phrases and VUI functions associated with the activation phrases. In addition, as the number of VUI functions increases, it becomes difficult for a user to remember all the activation words for the respective agent functions. Accordingly, one approach is to use common activation phrases for the VUI functions. In that case, however, when multiple VUI functions are activated at the same time, resource consumption increases.

The present disclosure provides an in-vehicle information processing device, an information processing method, and a program that can suppress an increase in resource consumption while allowing common activation words to be used for VUI functions.

An in-vehicle information processing device according to one embodiment of the present disclosure includes a control unit. The control unit has a plurality of VUI functions configured to be activated by the same activation phrase. The VUI functions are associated with respective in-vehicle functions. Each of the VUI functions is configured to perform speech recognition processing on an utterance from a user, recognize a voice command for an in-vehicle function, and execute the in-vehicle function based on the voice command. The control unit is configured to, when a predetermined in-vehicle function is active, activate the VUI function associated with the predetermined in-vehicle function in response to the activation phrase.

An in-vehicle information processing device according to one embodiment of the present disclosure includes a plurality of voice user interface functions configured to be activated by the same activation phrase. The voice user interface functions are associated with respective in-vehicle functions. The in-vehicle information processing device is configured to, when a predetermined in-vehicle function is active, activate the voice user interface function associated with the predetermined in-vehicle function in response to the activation phrase.

The in-vehicle information processing device may be configured to when an instruction to switch an in-vehicle function is received, newly activate an in-vehicle function based on the instruction, and activate the voice user interface function associated with the newly activated in-vehicle function, and terminate a rest of the voice user interface functions.

At least one of the voice user interface functions may be configured to be associated with multiple in-vehicle functions.

The in-vehicle information processing device may be configured to simultaneously activate the multiple in-vehicle functions associated with the at least one of the voice user interface functions.

A priority may be set for each of the in-vehicle functions.

The in-vehicle information processing device may be configured to, when multiple in-vehicle functions associated with multiple voice user interface functions are to be activated, activate the voice user interface function associated with the in-vehicle function having a highest priority.

An information processing method according to one embodiment of the present disclosure is executed by an in-vehicle information processing device having a plurality of voice user interface functions configured to be activated by the same activation phrase. The voice user interface functions being associated with respective in-vehicle functions. The information processing method includes causing the in-vehicle information processing device to, when a predetermined in-vehicle function is active, activate the voice user interface function associated with the predetermined in-vehicle function in response to the activation phrase.

The information processing method may further include causing the in-vehicle information processing device to when an instruction to switch an in-vehicle function is received, newly activate an in-vehicle function based on the instruction, and activate the voice user interface function associated with the newly activated in-vehicle function, and terminate a rest of the voice user interface functions.

At least one of the voice user interface functions may be configured to be associated with multiple in-vehicle functions.

The information processing method may further include causing the in-vehicle information processing device to simultaneously activate the multiple in-vehicle functions associated with the at least one of the voice user interface functions.

A priority may be set for each of the in-vehicle functions.

The information processing method may further include causing the in-vehicle information processing device to, when multiple in-vehicle functions associated with multiple voice user interface functions are to be activated, activate the voice user interface function associated with the in-vehicle function having a highest priority.

The present disclosure can suppress an increase in resource consumption while allowing common activation words to be used for VUI functions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a schematic configuration of an in-vehicle information processing device according to a first embodiment of the present disclosure;

FIG. 2 is a first flowchart illustrating an example of operation of the in-vehicle information processing device according to the first embodiment of the present disclosure;

FIG. 3 illustrates an example of a screen displayed at startup of the in-vehicle information processing device according to the first embodiment of the present disclosure;

FIG. 4 is a second flowchart illustrating an example of operation of the in-vehicle information processing device according to the first embodiment of the present disclosure;

FIG. 5 illustrates a schematic configuration of an in-vehicle information processing device according to a second embodiment of the present disclosure;

FIG. 6 illustrates an example of a screen displayed at startup of the in-vehicle information processing device according to the second embodiment of the present disclosure;

FIG. 7 is a flowchart illustrating an example of operation of the in-vehicle information processing device according to the second embodiment of the present disclosure;

FIG. 8 illustrates multiple in-vehicle functions activated by the in-vehicle information processing device according to the embodiment of the present disclosure;

FIG. 9 illustrates an example of in-vehicle functions associated with VUI function units of the in-vehicle information processing device according to the embodiment of the present disclosure; and

FIG. 10 is a flowchart illustrating an example of operation of the in-vehicle information processing device according to the embodiment of the present disclosure.

### DETAILED DESCRIPTION OF EMBODIMENTS

Embodiments of the present disclosure will be described in detail below with reference to the drawings.

### First Embodiment

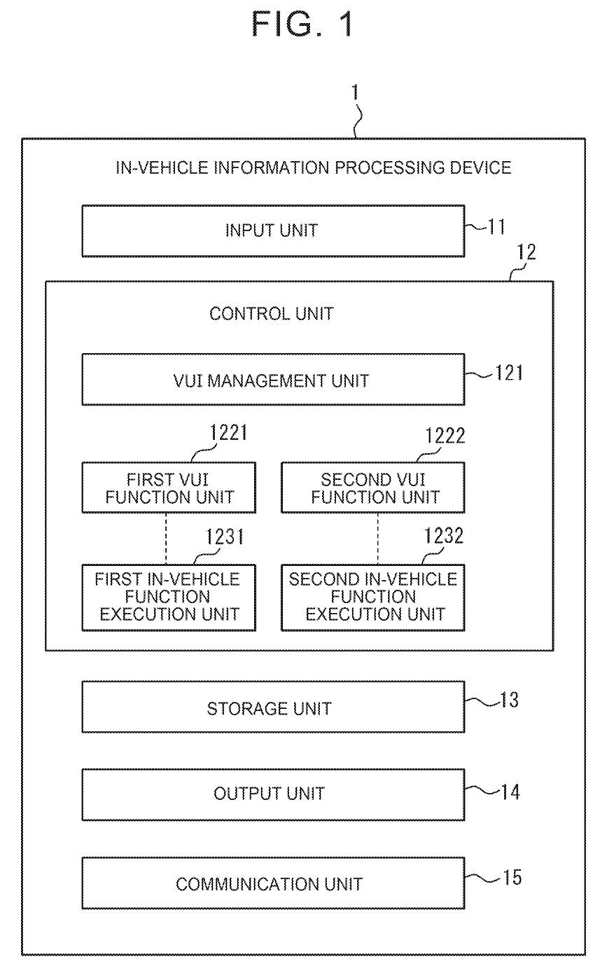

The configuration of an in-vehicle information processing device according to a first embodiment will be described with reference to FIG. 1. An in-vehicle information processing device 1 shown in FIG. 1 includes an input unit 11, a control unit 12, a storage unit 13, an output unit 14, and a communication unit 15.

The in-vehicle information processing device 1 is a multimedia device mounted on a vehicle and has a plurality of in-vehicle functions. The in-vehicle functions may include, for example, a navigation function, audio functions such as radio and television, information delivery functions such as news and weather, a vehicle connectivity function for communication with other vehicles, and a smart device connectivity function (e.g., with smartphones). The in-vehicle functions may also include functions for operating vehicle equipment such as an air conditioner, windows, wipers, lighting, roof, or shades. The in-vehicle information processing device 1 includes multiple voice user interface (VUI) functions that can be activated by the same activation phrase (wake-up word). The VUI functions are associated with the in-vehicle functions. When a predetermined in-vehicle function (typically the navigation function) is active, the VUI function associated with that in-vehicle function is activated in response to the activation phrase. The activation phrase may be, for example, "Hey Toyota!," but is not limited to this. The activation phrase may be changeable by a user through settings.

The input unit 11 includes a microphone that collects utterances from vehicle occupants. The input unit 11 may also include, for example, physical keys, capacitive keys, or a touch panel for receiving input from the user of the in-vehicle information processing device 1.

The storage unit 13 includes at least one semiconductor memory, at least one magnetic memory, at least one optical memory, or any combination thereof. The semiconductor memory may be, for example, random access memory (RAM), read-only memory (ROM), or flash memory. The storage unit 13 may function as, for example, a main storage device, an auxiliary storage device, or a cache memory. The storage unit 13 stores information used for the operation of the in-vehicle information processing device 1 and information obtained through the operation of the in-vehicle information processing device 1.

The output unit 14 includes at least one output interface. The output interface may be a display that outputs images generated by the control unit 12. The output interface may also be a speaker that outputs audio generated by the control unit 12. The input unit 11 and the output unit 14 may be integrated into one unit such as a touchscreen.

The communication unit 15 includes at least one communication interface for communicating with external devices such as servers or sensors. In the case of wired communication, the communication interface may conform to communication standards, such as a local area network (LAN) interface or a universal serial bus (USB) interface. In the case of wireless communication, the communication interface may conform to mobile communication standards, such as long term evolution (LTE), 4th generation (4G), or 5th generation (5G), or to short-range wireless communication such as Bluetooth. The communication unit 15 transmits information generated by the control unit 12 to external devices. The communication unit 15 also outputs information received from external devices to the storage unit 13.

The control unit 12 includes at least one processor, at least one programmable circuit, at least one dedicated circuit, or any combination thereof. The processor may be a general-purpose processor such as a central processing unit (CPU) or a graphics processing unit (GPU), or a dedicated processor specialized for particular processing. The programmable circuit may be, for example, a field-programmable gate array (FPGA). The dedicated circuit may be, for example, an application-specific integrated circuit (ASIC). The control unit 12 performs processing related to the operation of the in-vehicle information processing device 1 while controlling each unit of the in-vehicle information processing device 1.

The control unit 12 includes a VUI management unit 121, N VUI function units 122k (1 ≤ k ≤ N), and N in-vehicle function execution units 123k (1 ≤ k ≤ N), where N is the number of VUIs and is an integer of 2 or more. In FIG. 1, the number of VUIs is two (N = 2), with a first VUI function unit 1221 and a second VUI function unit 1222 shown as examples of the VUI function units 122k, and a first in-vehicle function execution unit 1231 and a second in-vehicle function execution unit 1232 shown as examples of the in-vehicle function execution units 123k. The VUI function units 122k and the in-vehicle function execution units 123k may all be in-house products, or some may be in-house products while the rest may be other companies' products (third-party products).

The VUI management unit 121 controls activation (turning on) and termination (turning off) of the VUI function units 122k. When a VUI function unit 122k is activated, it first enters a standby mode. The standby mode refers to a state in which the VUI function unit 122k is waiting for an activation phrase. In the standby mode, the microphone is always on and voice input is monitored. In addition, no advanced processing is performed until an activation phrase is detected. When in the inactive state, the VUI function unit 122k disables voice input, that is, it does not wait for an activation phrase.

The VUI function units 122k are activated by the same activation phrase. In this specification, "a VUI function unit 122k is activated by an activation phrase" means that the VUI function unit 122k detects the activation phrase and switches from the standby mode to an active mode. The active mode refers to a state in which the VUI function unit 122k is ready to receive voice instructions from the user. In the active mode, natural language processing, cloud communication, etc. are used to execute the user's requests. The VUI function units 122k are associated with (linked to) the respective in-vehicle functions. For example, it is assumed that a first in-vehicle function is associated with the first VUI function unit 1221, and a second in-vehicle function is associated with the second VUI function unit 1222. In this case, when the first in-vehicle function is active, the first VUI function unit 1221 associated with the first in-vehicle function is activated. Similarly, when the second in-vehicle function is active, the second VUI function unit 1222 associated with the second in-vehicle function is activated.

A VUI function unit 122k interacts with the user and performs agent processing such as speech recognition processing and natural language processing. When a VUI function unit 122k recognizes a command (voice command) from the user for an in-vehicle function, it outputs the voice command to a corresponding in-vehicle function execution unit 123k to cause the in-vehicle function execution unit 123k to execute the in-vehicle function associated with the VUI function unit 122k. The speech recognition processing may include, as preprocessing, noise reduction processing for removing background noise contained in a speech signal. A VUI function unit 122k may perform speech recognition processing and natural language processing using artificial intelligence (AI). For example, a VUI function unit 122k may extract phonemes using an acoustic model and understand context using a language model such as a hidden Markov model (HMM) or an N-gram. A VUI function unit 122k may use not only a deep neural network-hidden Markov model (DNN-HMM) but also other known models such as an end-to-end model.

An in-vehicle function execution unit 123k executes an in-vehicle function associated with a corresponding VUI function unit 122k based on a voice command input from the VUI function unit 122k. An in-vehicle function execution unit 123k may also execute an in-vehicle function associated with a corresponding VUI function unit 122k based on an operation command input by the user operating the input unit 11. That is, the first in-vehicle function execution unit 1231 executes the in-vehicle function associated with the first VUI function unit 1221, and the second in-vehicle function execution unit 1232 executes the in-vehicle function associated with the second VUI function unit 1222. The in-vehicle function associated with a VUI function unit 122k may be a single function or multiple functions. For example, the in-vehicle function associated with the first VUI function unit 1221 may be an in-house navigation application, and the in-vehicle function associated with the second VUI function unit 1222 may be a navigation application from another company (third party). As another example, the in-vehicle function associated with the first VUI function unit 1221 may be an in-vehicle function having a significant impact on vehicle safety, and the in-vehicle function associated with the second VUI function unit 1222 may be an in-vehicle function that does not have a significant impact on vehicle safety and an in-vehicle function from another company (third party).

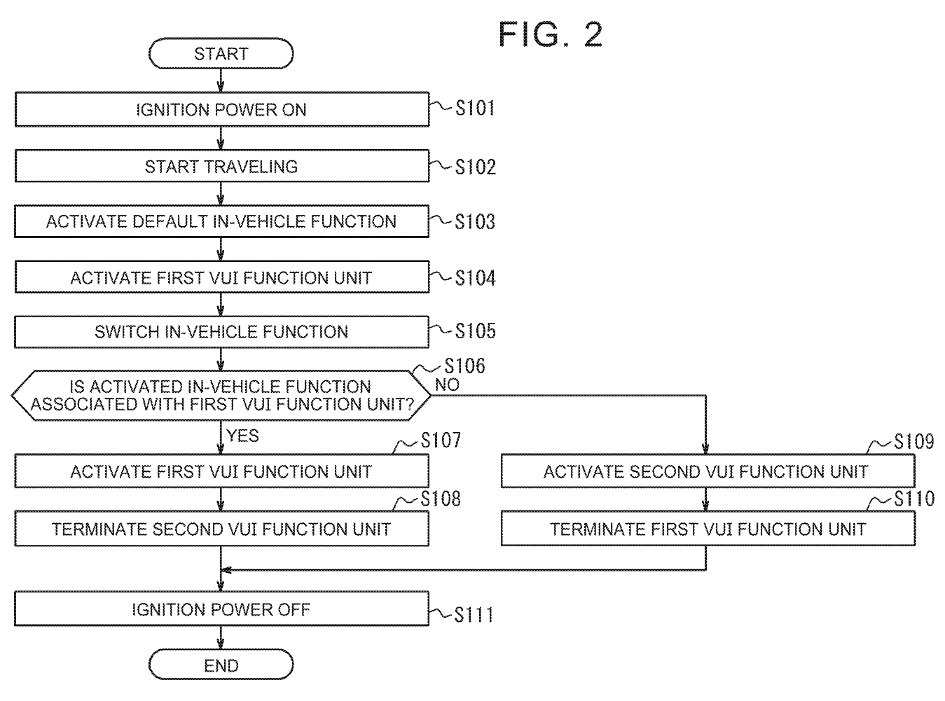

Next, an example of operation of a vehicle equipped with the in-vehicle information processing device 1 according to the first embodiment will be described. FIG. 2 is a flowchart illustrating an example of operation when the user of the in-vehicle information processing device 1 switches between in-vehicle functions during the period from startup to shutdown of the in-vehicle information processing device 1.

In S101, when the ignition power is turned on, the in-vehicle information processing device 1 starts up. In S102, the vehicle starts traveling.

In S103, the control unit 12 activates a predetermined in-vehicle function (for example, an in-house navigation application) as a default setting.

In S104, the VUI management unit 121 activates the VUI function unit 122k associated with the in-vehicle function activated in S103 and sets it to the standby mode. It is herein assumed that the first VUI function unit 1221 is activated.

In S105, the user operates the input unit 11 (for example, touches an icon on a touchscreen) and inputs an instruction to switch the in-vehicle function. That is, the control unit 12 receives an instruction to switch the in-vehicle function from the input unit 11. The control unit 12 then terminates the currently active in-vehicle function, and based on the switching instruction, newly activates an in-vehicle function.

In S106, the VUI management unit 121 determines whether the in-vehicle function activated in S105 is associated with the first VUI function unit 1221. When the in-vehicle function activated in S105 is associated with the first VUI function unit 1221, the process proceeds to S107. When the in-vehicle function activated in S105 is associated with the second VUI function unit 1222, the process proceeds to S109. The processing from S105 to S110 may be repeated.

In S107, when the first VUI function unit 1221 is active, no processing is performed. When the processing from S105 to S110 is repeated and, in the course of the repetition, the first VUI function unit 1221 has been inactive, the VUI management unit 121 activates the first VUI function unit 1221 and sets it to the standby mode.

In S108, when the second VUI function unit 1222 is inactive, no processing is performed. When the processing from S105 to S110 is repeated and, in the course of the repetition, the second VUI function unit 1222 has been active, the VUI management unit 121 terminates the second VUI function unit 1222 and sets it to the inactive state.

In S109, the VUI management unit 121 activates the second VUI function unit 1222 and sets it to the standby mode. When the processing from S105 to S110 is repeated and, in the course of the repetition, the second VUI function unit 1222 has been active, no processing is performed.

In S110, the VUI management unit 121 terminates the first VUI function unit 1221 and sets it to the inactive state. When the processing from S105 to S110 is repeated and, in the course of the repetition, the first VUI function unit 1221 has been inactive, no processing is performed.

In S111, when the ignition power is turned off, the in-vehicle information processing device 1 shuts down and ends its processing.

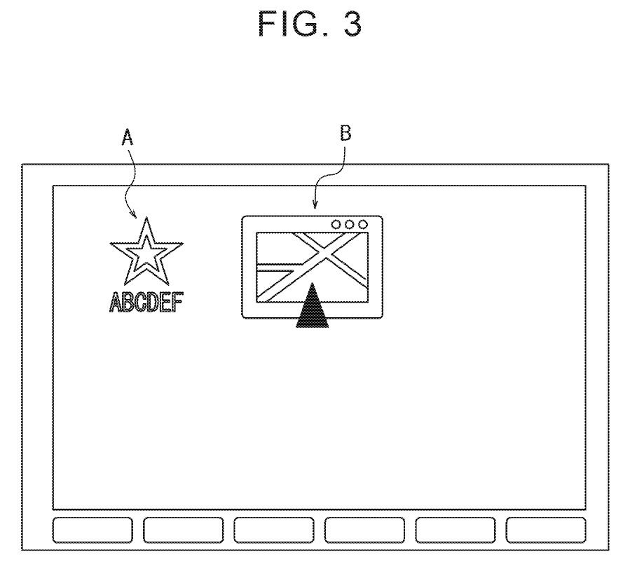

In FIG. 2, an example is illustrated in which a default in-vehicle function is activated at startup of the in-vehicle information processing device 1. However, an in-vehicle function may not be preset as a default. As shown in FIG. 3, at startup, the in-vehicle information processing device 1 may display multiple icons of in-vehicle functions on a screen such as a touchscreen such that the user can select an in-vehicle function. FIG. 3 shows an example in which two in-vehicle function icons A, B are displayed.

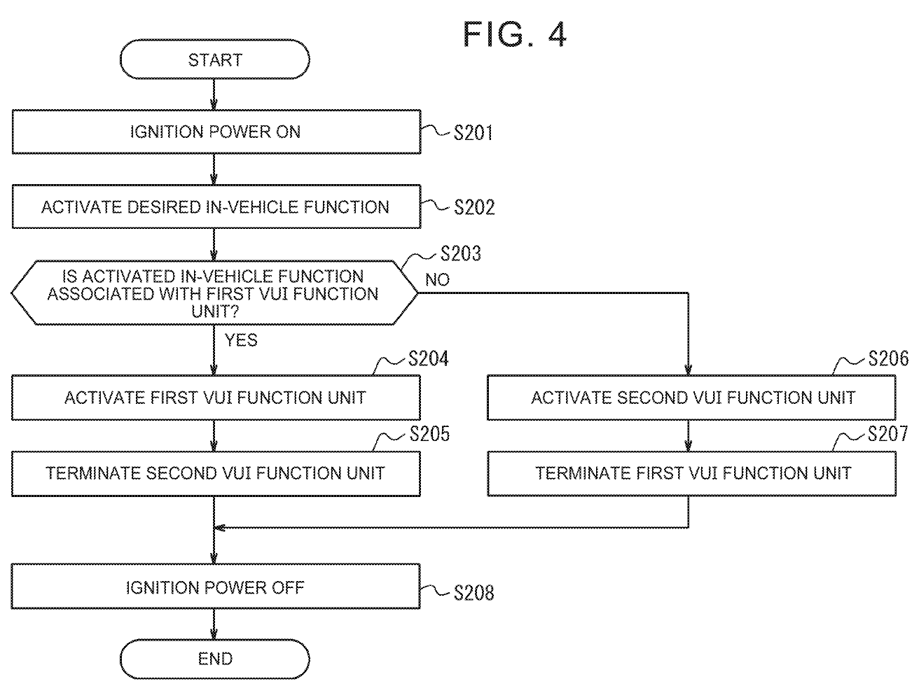

FIG. 4 is a flowchart illustrating an example of operation when the user selects an in-vehicle function at startup of the in-vehicle information processing device 1. There is no limitation on the number of in-vehicle functions. However, for example, two in-vehicle functions may be provided, with the first in-vehicle function being associated with the first VUI function unit 1221 and the second in-vehicle function being associated with the second VUI function unit 1222.

In S201, when the ignition power is turned on, the in-vehicle information processing device 1 starts up.

In S202, the user of the in-vehicle information processing device 1 operates the input unit 11 (for example, touches an icon on a touchscreen) and inputs an instruction to activate an in-vehicle function. That is, the control unit 12 receives an instruction to activate an in-vehicle function from the input unit 11. The control unit 12 then newly activates an in-vehicle function based on the instruction.

In S203, the VUI management unit 121 determines whether the in-vehicle function activated in S202 is associated with the first VUI function unit 1221. When the in-vehicle function activated in S202 is associated with the first VUI function unit 1221, the process proceeds to S204. When the in-vehicle function activated in S202 is associated with the second VUI function unit 1222, the process proceeds to S206. The processing from S202 to S207 may be repeated.

In S204, the VUI management unit 121 activates the first VUI function unit 1221 and sets it to the standby mode.

In S205, when the second VUI function unit 1222 is inactive, no processing is performed. When the processing from S202 to S207 is repeated and, in the course of the repetition, the second VUI function unit 1222 has been active, the VUI management unit 121 terminates the second VUI function unit 1222 and sets it to the inactive state.

In S206, the VUI management unit 121 activates the second VUI function unit 1222 and sets it to the standby mode.

In S207, when the first VUI function unit 1221 is inactive, no processing is performed. When the processing from S202 to S207 is repeated and, in the course of the repetition, the first VUI function unit 1221 has been active, the VUI management unit 121 terminates the first VUI function unit 1221 and sets it to the inactive state.

In S208, when the ignition power is turned off, the in-vehicle information processing device 1 shuts down and ends its processing.

### Second Embodiment

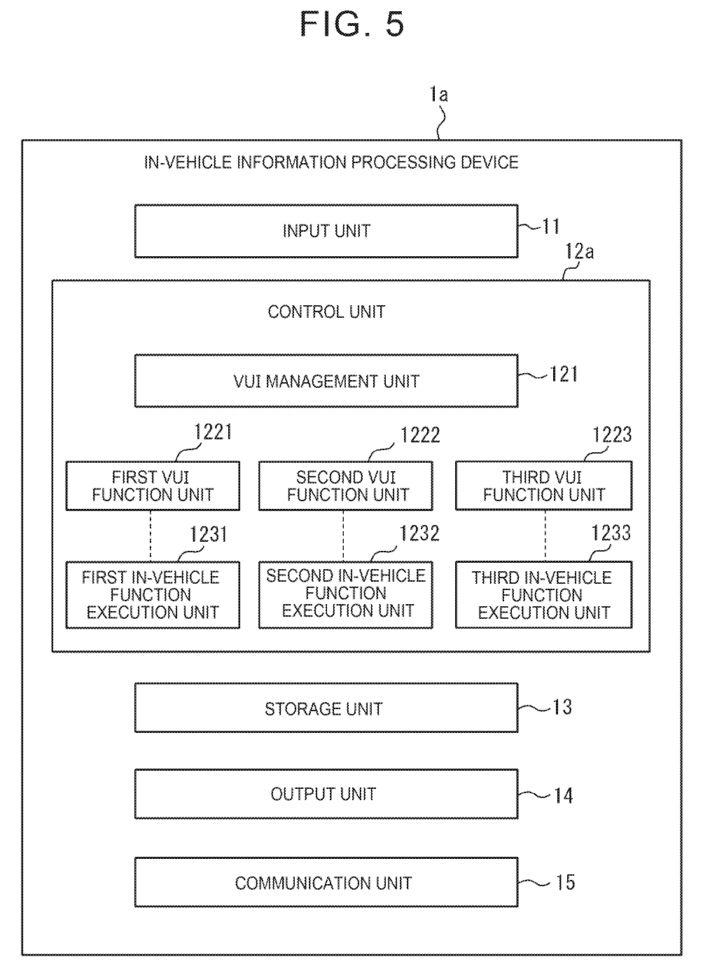

Next, an in-vehicle information processing device according to a second embodiment will be described. An in-vehicle information processing device 1a shown in FIG. 5 includes an input unit 11, a control unit 12a, a storage unit 13, an output unit 14, and a communication unit 15. The in-vehicle information processing device 1a differs from the in-vehicle information processing device 1 shown in FIG. 1 in the operation of the control unit 12a. Since the configuration is otherwise the same as that of the in-vehicle information processing device 1, the description thereof will be omitted.

In the in-vehicle information processing device 1 shown in FIG. 1, the number of VUIs is two (N = 2). The in-vehicle information processing device 1a differs from the in-vehicle information processing device 1 in that the number of VUIs is three (N = 3). That is, the control unit 12a includes a VUI management unit 121, VUI function units 122k (a first VUI function unit 1221, a second VUI function unit 1222, and a third VUI function unit 1223), and in-vehicle function execution units 123k (a first in-vehicle function execution unit 1231, a second in-vehicle function execution unit 1232, and a third in-vehicle function execution unit 1233).

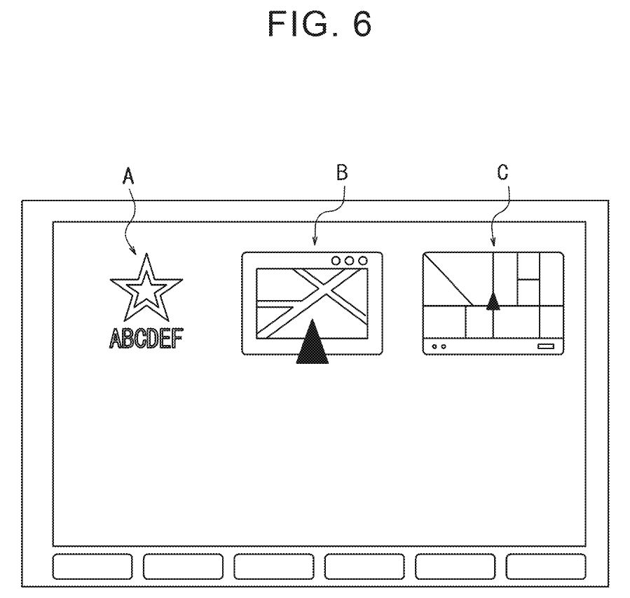

FIG. 3 shows an example in which two in-vehicle functions are provided. However, the number of in-vehicle functions may be three or more. For example, as shown in FIG. 6, at startup, the in-vehicle information processing device 1a may display three in-vehicle function icons A, B, and C on a screen such as a touchscreen.

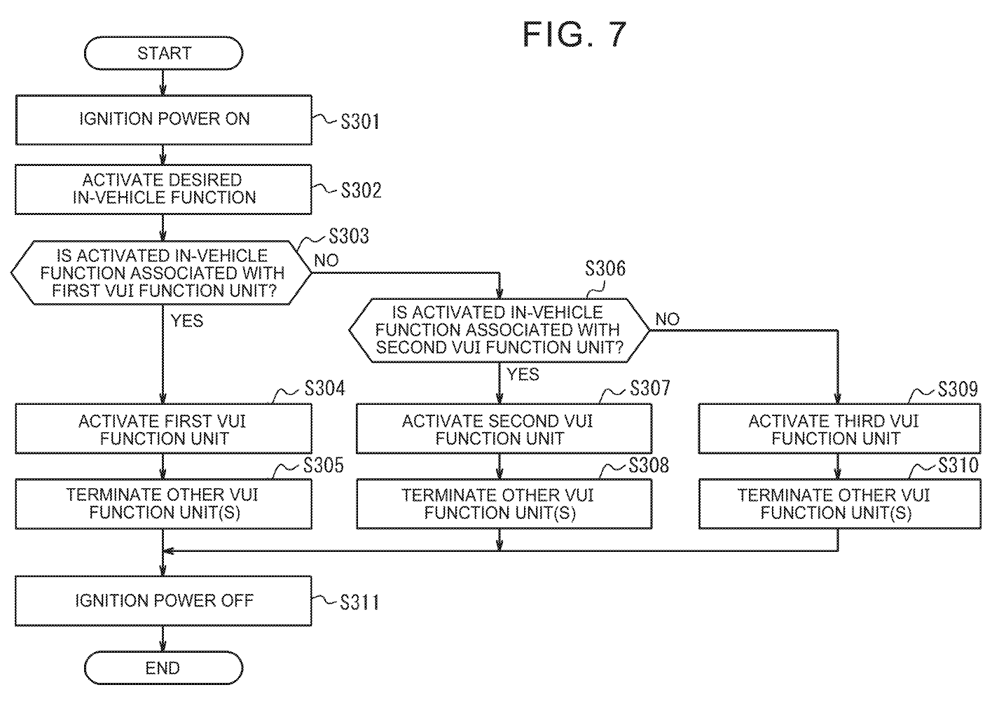

FIG. 7 is a flowchart illustrating an example of operation when the user selects an in-vehicle function at startup of the in-vehicle information processing device 1a. There is no limitation on the number of in-vehicle functions. However, for example, three in-vehicle functions may be provided, with the first in-vehicle function being associated with the first VUI function unit 1221, the second in-vehicle function being associated with the second VUI function unit 1222, and the third in-vehicle function being associated with the third VUI function unit 1223.

In S301, when the ignition power is turned on, the in-vehicle information processing device 1a starts up.

In S302, the user operates the input unit 11 and inputs an instruction to activate an in-vehicle function. The control unit 12 then newly activates an in-vehicle function based on the instruction.

In S303, the VUI management unit 121 determines whether the in-vehicle function activated in S302 is associated with the first VUI function unit 1221. When the in-vehicle function activated in S302 is associated with the first VUI function unit 1221, the process proceeds to S304. When the in-vehicle function activated in S302 is not associated with the first VUI function unit 1221, the process proceeds to S306. The processing from S302 to S310 may be repeated.

In S304, the VUI management unit 121 activates the first VUI function unit 1221 and sets it to the standby mode.

In S305, when the second VUI function unit 1222 and the third VUI function unit 1223 are inactive, no processing is performed. When the processing from S302 to S310 is repeated and, in the course of the repetition, the second VUI function unit 1222 or the third VUI function unit 1223, or both, have been active, the VUI management unit 121 terminates whichever of the second VUI function unit 1222 or the third VUI function unit 1223, or both, have been active and sets them to the inactive state.

In S306, the VUI management unit 121 determines whether the in-vehicle function activated in S302 is associated with the second VUI function unit 1222. When the activated in-vehicle function is associated with the second VUI function unit 1222, the process proceeds to S307. When the activated in-vehicle function is not associated with the second VUI function unit 1222, the process proceeds to S309.

In S307, the VUI management unit 121 activates the second VUI function unit 1222 and sets it to the standby mode.

In S308, when the first VUI function unit 1221 and the third VUI function unit 1223 are inactive, no processing is performed. When the processing from S302 to S310 is repeated and, in the course of the repetition, the first VUI function unit 1221 or the third VUI function unit 1223, or both, have been active, the VUI management unit 121 terminates whichever of the first VUI function unit 1221 or the third VUI function unit 1223, or both, have been active and sets them to the inactive state.

In S309, the VUI management unit 121 activates the third VUI function unit 1223 and sets it to the standby mode.

In S310, when the first VUI function unit 1221 and the second VUI function unit 1222 are inactive, no processing is performed. When the processing from S302 to S310 is repeated and, in the course of the repetition, the first VUI function unit 1221 or the second VUI function unit 1222, or both, have been active, the VUI management unit 121 terminates whichever of the first VUI function unit 1221 or the second VUI function unit 1222, or both, have been active and sets them to the inactive state.

In S311, when the ignition power is turned off, the in-vehicle information processing device 1a shuts down and ends its processing.

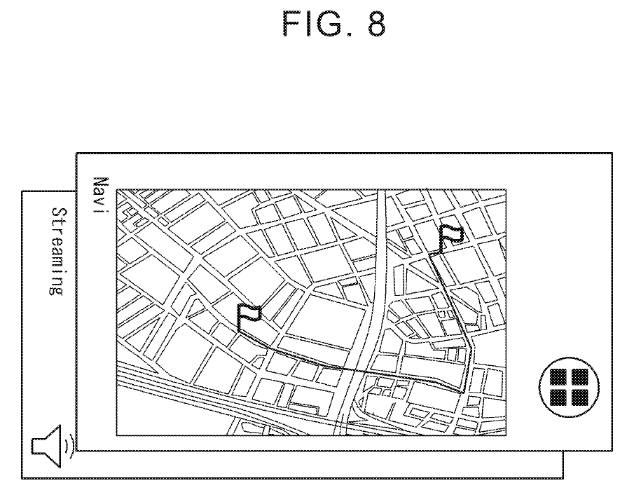

In the above example of operation, each VUI function unit 122k is associated with a single in-vehicle function. However, a single VUI function unit 122k may be associated with multiple in-vehicle functions. The in-vehicle functions may be configured such that multiple in-vehicle functions can be activated simultaneously. For example, as shown in FIG. 8, the in-vehicle functions associated with a VUI function unit 122k may include a navigation application and an audio application that plays audio (streaming) in the background of the navigation application, and the navigation application and the audio application may be launched simultaneously.

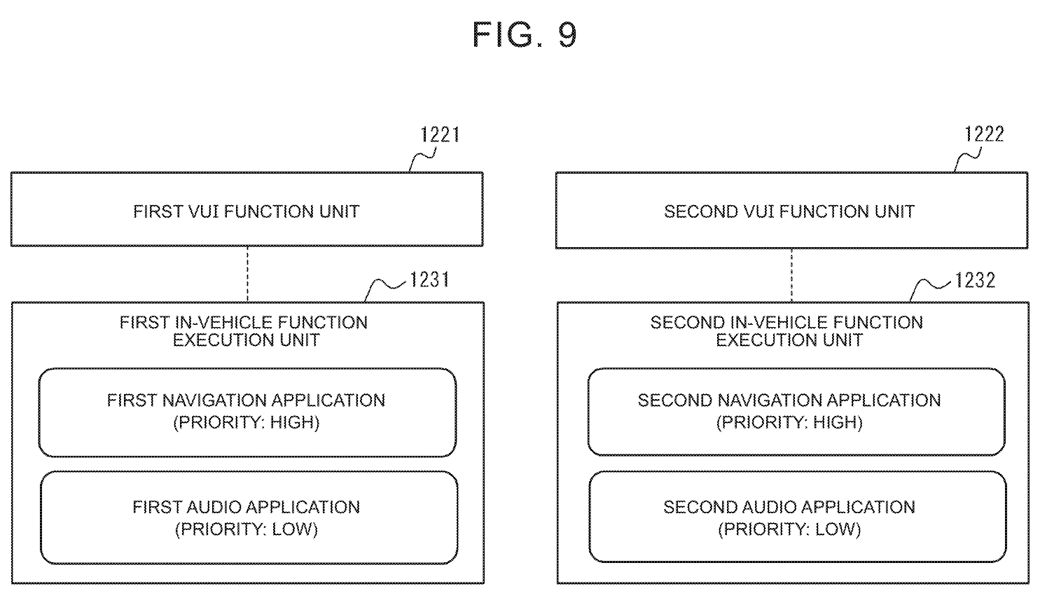

As shown in FIG. 9, the in-vehicle functions, such as a first navigation application and a first audio application, may be associated with the first VUI function unit 1221, and the first navigation application and the first audio application may be launched simultaneously. Similarly, the in-vehicle functions, such as a second navigation application and a second audio application, may be associated with the second VUI function unit 1222, and the second navigation application and the second audio application may be launched simultaneously. It may also be possible to activate the first VUI function unit 1221 and launch the first navigation application and the second audio application simultaneously, or to activate the second VUI function unit 1222 and launch the second navigation application and the first audio application simultaneously. Furthermore, when multiple in-vehicle functions can be activated simultaneously, a priority may be set in advance for each in-vehicle function. The priority may be changeable by the user. The priority may be stored in the storage unit 13.

In the example shown in FIG. 9, the priority of the first navigation application is set high, and the priority of the first audio application is set low. Similarly, the priority of the second navigation application is set high, and the priority of the second audio application is set low. The priority may be set numerically, with higher priorities represented by larger values.

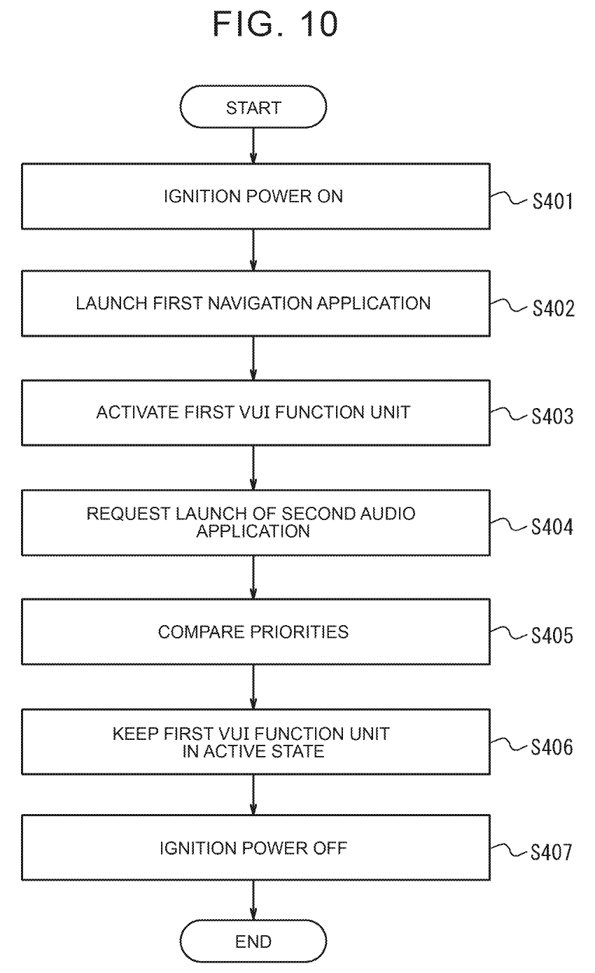

FIG. 10 is a flowchart illustrating an example of operation when the user selects an in-vehicle function at startup of the in-vehicle information processing device 1, 1a. It is herein assumed that the in-vehicle information processing device 1, 1a has the in-vehicle functions shown in FIG. 9, and that a priority is set for each in-vehicle function.

In S401, when the ignition power is turned on, the in-vehicle information processing device 1, 1a starts up.

In S402, the user operates the input unit 11 and requests launch of the first navigation application. The control unit 12, 12a then launches the first navigation application selected by the user.

In S403, the VUI management unit 121 activates the first VUI function unit 1221 associated with the first navigation application and sets it to the standby mode.

In S404, the user operates the input unit 11 and requests launch of the second audio application. The control unit 12, 12a then launches the second audio application requested by the user.

In S405, the VUI management unit 121 compares the priorities of the first navigation application and the second audio application. As shown in FIG. 9, it is herein assumed that the priority of the first navigation application is higher than that of the second audio application.

In S406, since the priority of the first navigation application is higher, the VUI management unit 121 does not activate the second VUI function unit 1222, and keeps the first VUI function unit 1221 in the active state. That is, when multiple in-vehicle functions associated with multiple VUI function units 122k are to be activated simultaneously, the VUI management unit 121 places in the active state the VUI function unit 122k associated with the in-vehicle function having the highest priority.

In S407, when the ignition power is turned off, the in-vehicle information processing device 1, 1a shuts down and ends its processing.

The above embodiments illustrate the cases where the number of VUIs is two and three (N = 2, 3), respectively. However, it is evident that the same processing can be performed when N is four or more. Furthermore, the present disclosure is not limited to the operation examples described above. As described above, the VUI functions of the in-vehicle information processing device 1, 1a are activated by the same activation phrase. Therefore, the user neither needs to have knowledge of the combinations of activation phrases and VUI functions associated with the activation phrases, nor needs to memorize multiple activation phrases. This makes it possible to improve the operability of in-vehicle functions. Moreover, the in-vehicle information processing device 1, 1a can readily incorporate a large number of VUI functions. For example, in order to support different languages in different countries and regions, the in-vehicle information processing device 1, 1a may incorporate different VUI functions for each language, or may incorporate VUI functions provided by vendors specializing in particular languages. In addition, since the user can operate various in-vehicle functions by voice through the VUI functions without diverting their eyes, it is possible to improve safety while driving.

In the in-vehicle information processing device 1, 1a, when a predetermined in-vehicle function is active, the VUI function associated with that in-vehicle function is activated in response to the activation phrase. In other words, the VUI function associated with the in-vehicle function is placed in the standby state, while the other VUI functions are placed in the non-standby state. Therefore, the VUI function associated with the in-vehicle function waits for the activation phrase. Accordingly, resources are optimized, and the in-vehicle information processing device 1, 1a can suppress an increase in resource consumption. Multiple VUI functions (for example, VUI functions optimized for different languages) can also be incorporated into systems with limited resources (for example, a navigation system). In addition, since the in-vehicle information processing device 1, 1a does not activate multiple VUI functions at the same time, task dispatching is less likely to occur due to parallel processing, and an increase in processing time can be suppressed.

When multiple in-vehicle functions associated with multiple VUI functions are to be activated simultaneously, the in-vehicle information processing device 1, 1a activate the VUI function associated with the in-vehicle function having the highest priority. Accordingly, when an attempt is made to simultaneously activate multiple in-vehicle functions associated with different VUI functions, which VUI function to activate can be appropriately determined.

### Program

A computer capable of executing program instructions can be used to implement the functions of the in-vehicle information processing device 1, 1a described above. The program causes a computer to perform the operations described above, thereby enabling the computer to function as the in-vehicle information processing device 1, 1a.

The program may be stored in a non-transitory computer-readable medium. Examples of such a non-transitory computer-readable medium include flash memory, a magnetic recording device, an optical disc, a magneto-optical recording medium, and ROM. The program may be distributed by, for example, selling, transferring, or lending a portable medium such as a secure digital (SD) card, a digital versatile disc (DVD), or a compact disc read-only memory (CD-ROM) in which the program is stored. Alternatively, the program may be distributed by storing the program in the storage of a server and transferring the program from the server to other computers. The program may be provided as a program product.

The computer may temporarily store, in the storage unit 13, the program stored in a portable medium or transferred from a server. The computer then reads the program stored in the storage unit 13 with a processor (control unit 12) and executes processing according to the program with the processor. The processor may be a central processing unit (CPU), a micro-processing unit (MPU), or a system on a chip (SoC), and may be configured by a plurality of processors of the same or different types.

The computer may read the program directly from a portable medium and execute processing according to the program. The computer may execute processing according to the program each time the program is transferred from a server to the computer. Alternatively, processing may be executed by a so-called application service provider (ASP) service. In this case, the program is not transferred from a server to the computer, and the functions are implemented through execution instructions and result acquisition. The program includes information that is to be used in processing by an electronic computer and that is equivalent to a program. For example, data that is not a direct command to a computer but defines the processing executed by the computer corresponds to "information equivalent to a program."

Although the above embodiments have been described as representative examples, various modifications and changes may be made without departing from the spirit and scope of the present disclosure. For example, two or more of the configuration blocks or processing steps described in the embodiments may be combined into one, or one configuration block or processing step may be divided into two or more configuration blocks or processing steps.

Part of the embodiments of the present disclosure will now be illustrated. However, the embodiments of the present disclosure are not limited to these.

### First Aspect

An in-vehicle information processing device including a control unit, wherein:

the control unit has a plurality of VUI functions configured to be activated by the same activation phrase;

the VUI functions are associated with respective in-vehicle functions;

each of the VUI functions is configured to perform speech recognition processing on an utterance from a user, recognize a voice command for an in-vehicle function, and execute, based on the voice command, the in-vehicle function associated with the VUI function; and

the control unit is configured to, when a predetermined in-vehicle function is active, activate the VUI function associated with the predetermined in-vehicle function in response to the activation phrase.

### Second Aspect

An in-vehicle information processing device including a plurality of VUI functions configured to be activated by the same activation phrase, wherein:

the VUI functions are associated with respective in-vehicle functions; and

the in-vehicle information processing device is configured to, when a predetermined in-vehicle function is active, activate the VUI function associated with the predetermined in-vehicle function in response to the activation phrase.

### Third Aspect

The in-vehicle information processing device according to the first or second aspect, wherein the in-vehicle information processing device is configured to

when an instruction to switch an in-vehicle function is received, newly activate an in-vehicle function based on the instruction, and

activate the VUI function associated with the newly activated in-vehicle function, and terminate the rest of the VUI functions.

### Fourth Aspect

The in-vehicle information processing device according to any one of the first to third aspects, wherein at least one of the VUI functions is configured to be associated with multiple in-vehicle functions.

### Fifth Aspect

The in-vehicle information processing device according to the fourth aspect, wherein the in-vehicle information processing device is configured to simultaneously activate the multiple in-vehicle functions associated with the at least one of the VUI functions.

### Sixth Aspect

The in-vehicle information processing device according to the fifth aspect, wherein a priority is configured to be set for each of the in-vehicle functions.

### Seventh Aspect

The in-vehicle information processing device according to the sixth aspect, wherein the in-vehicle information processing device is configured to, when multiple in-vehicle functions associated with multiple VUI functions are to be activated, activate the VUI function associated with the in-vehicle function having the highest priority.

### Eighth Aspect

An information processing method that is executed by an in-vehicle information processing device having a plurality of VUI functions configured to be activated by the same activation phrase, the VUI functions being associated with respective in-vehicle functions, the information processing method including causing the in-vehicle information processing device to

perform speech recognition processing on an utterance from a user, recognize a voice command for an in-vehicle function, and execute the in-vehicle function based on the voice command, and

when a predetermined in-vehicle function is active, activate the VUI function associated with the predetermined in-vehicle function in response to the activation phrase.

### Ninth Aspect

An information processing method that is executed by an in-vehicle information processing device having a plurality of VUI functions configured to be activated by the same activation phrase, the VUI functions being associated with respective in-vehicle functions, the information processing method including causing the in-vehicle information processing device to when a predetermined in-vehicle function is active, activate the VUI function associated with the predetermined in-vehicle function in response to the activation phrase.

### Tenth Aspect

The information processing method according to the eighth or ninth aspect, further including causing the in-vehicle information processing device to

when an instruction to switch an in-vehicle function is received, newly activate an in-vehicle function based on the instruction, and

activate the VUI function associated with the newly activated in-vehicle function, and terminate the rest of the VUI functions.

### Eleventh Aspect

The information processing method according to any one of the eighth to tenth aspects, wherein at least one of the VUI functions is associated with multiple in-vehicle functions.

### Twelfth Aspect

The information processing method according to the eleventh aspect, further including causing the in-vehicle information processing device to simultaneously activate the multiple in-vehicle functions associated with the at least one of the VUI functions.

### Thirteenth Aspect

The information processing method according to the twelfth aspect, wherein a priority is set for each of the in-vehicle functions.

### Fourteenth Aspect

The information processing method according to the thirteenth aspect, further including causing the in-vehicle information processing device to, when multiple in-vehicle functions associated with multiple VUI functions are to be activated, activate the VUI function associated with the in-vehicle function having the highest priority.

### Fifteenth Aspect

A program to be executed by a computer that functions as an in-vehicle information processing device having a plurality of VUI functions configured to be activated by the same activation phrase, wherein:

the VUI functions are associated with respective in-vehicle functions; and

the program causes the computer to

perform speech recognition processing on an utterance from a user, recognize a voice command for an in-vehicle function, and execute the in-vehicle function based on the voice command, and

when a predetermined in-vehicle function is active, activate the VUI function associated with the predetermined in-vehicle function in response to the activation phrase.

### Sixteenth Aspect

A program to be executed by a computer that functions as an in-vehicle information processing device having a plurality of VUI functions configured to be activated by the same activation phrase, wherein:

the VUI functions are associated with respective in-vehicle functions; and

the program causes the computer to, when a predetermined in-vehicle function is active, activate the VUI function associated with the predetermined in-vehicle function in response to the activation phrase.

### Seventeenth Aspect

The program according to the fifteenth or sixteenth aspect, wherein the program causes the computer to

when an instruction to switch an in-vehicle function is received, newly activate an in-vehicle function based on the instruction, and

activate the VUI function associated with the newly activated in-vehicle function, and terminate the rest of the VUI functions.

### Eighteenth Aspect

The program according to any one of the fifteenth to seventeenth aspects, wherein at least one of the VUI functions is associated with multiple in-vehicle functions.

### Nineteenth Aspect

The program according to the eighteenth aspect, wherein that program causes the computer to simultaneously activate the multiple in-vehicle functions associated with the at least one of the VUI functions.

### Twentieth Aspect

The program according to the nineteenth aspect, wherein:

a priority is set for each of the in-vehicle functions; and

the program causes the computer to, when multiple in-vehicle functions associated with multiple VUI functions are to be activated, activate the VUI function associated with the in-vehicle function having the highest priority.

What is claimed is:

1. An in-vehicle information processing device comprising a control unit, wherein:
the control unit has a plurality of voice user interface functions configured to be activated by the same activation phrase;
the voice user interface functions are associated with respective in-vehicle functions;
each of the voice user interface functions is configured to perform speech recognition processing on an utterance from a user, recognize a voice command, and execute, based on the voice command, the in-vehicle function associated with the voice user interface function; and
the control unit is configured to, when a predetermined in-vehicle function is active, activate the voice user interface function associated with the predetermined in-vehicle function in response to the activation phrase.

2. An in-vehicle information processing device comprising a plurality of voice user interface functions configured to be activated by the same activation phrase, wherein:
the voice user interface functions are associated with respective in-vehicle functions; and
the in-vehicle information processing device is configured to, when a predetermined in-vehicle function is active, activate the voice user interface function associated with the predetermined in-vehicle function in response to the activation phrase.

3. The in-vehicle information processing device according to claim 2, wherein the in-vehicle information processing device is configured to
when an instruction to switch an in-vehicle function is received, newly activate an in-vehicle function based on the instruction, and
activate the voice user interface function associated with the newly activated in-vehicle function, and terminate a rest of the voice user interface functions.

4. The in-vehicle information processing device according to claim 2, wherein at least one of the voice user interface functions is configured to be associated with multiple in-vehicle functions.

5. The in-vehicle information processing device according to claim 4, wherein the in-vehicle information processing device is configured to simultaneously activate the multiple in-vehicle functions associated with the at least one of the voice user interface functions.

6. The in-vehicle information processing device according to claim 5, wherein a priority is set for each of the in-vehicle functions.

7. The in-vehicle information processing device according to claim 6, wherein the in-vehicle information processing device is configured to, when multiple in-vehicle functions associated with multiple voice user interface functions are to be activated, activate the voice user interface function associated with the in-vehicle function having a highest priority.

8. An information processing method that is executed by an in-vehicle information processing device having a plurality of voice user interface functions configured to be activated by the same activation phrase, the voice user interface functions being associated with respective in-vehicle functions, the information processing method comprising causing the in-vehicle information processing device to, when a predetermined in-vehicle function is active, activate the voice user interface function associated with the predetermined in-vehicle function in response to the activation phrase.

9. The information processing method according to claim 8, further comprising causing the in-vehicle information processing device to
when an instruction to switch an in-vehicle function is received, newly activate an in-vehicle function based on the instruction, and
activate the voice user interface function associated with the newly activated in-vehicle function, and terminate a rest of the voice user interface functions.

10. The information processing method according to claim 8, wherein at least one of the voice user interface functions is configured to be associated with multiple in-vehicle functions.

11. The information processing method according to claim 10, further comprising causing the in-vehicle information processing device to simultaneously activate the multiple in-vehicle functions associated with the at least one of the voice user interface functions.

12. The information processing method according to claim 11, wherein a priority is set for each of the in-vehicle functions.

13. The information processing method according to claim 12, further comprising causing the in-vehicle information processing device to, when multiple in-vehicle functions associated with multiple voice user interface functions are to be activated, activate the voice user interface function associated with the in-vehicle function having a highest priority.
